(19) United States
(12) Patent Application Publication
(10) Pub. No.: US 2012/0163535 A1
(43) Pub. Date: Jun. 28, 2012

(54) GRID FOR RADIOGRAPHY AND REPAIRING METHOD THEREOF, AND RADIATION IMAGING SYSTEM

(75) Inventor: Yasuhisa KANEKO, Ashigarakami-gun (JP)

(73) Assignee: FUJIFILM CORPORATION, Tokyo (JP)

(21) Appl. No.: 13/306,734

(22) Filed: Nov. 29, 2011

(30) Foreign Application Priority Data
Dec. 22, 2010 (JP) 2010-285385
Sep. 2, 2011 (JP) 2011-191911

(51) Int. Cl. G01N 23/04; B23P 6/00; G21K 1/00

(52) U.S. Cl. 378/62; 378/154; 29/402.11

(57) ABSTRACT

In a second grid, X-ray absorbing portions and X-ray transparent portions extending in a Y direction are alternately arranged in an X direction. After the manufacture of the second grid, a defective portion is detected in the second grid. A rectangular area to be cut out is set along the X and Y directions so as to enclose this defective portion. By cutting out the rectangular area, a cutout is formed. A micro grid, which is smaller than the cutout, is fitted into the cutout such that two adjoining sides of the micro grid are in contact with two adjoining sides of the cutout. A gap left between an outline of the cutout and the micro grid is filled with Sn—Pb as an X-ray absorbing material.

### BACKGROUND OF THE INVENTION

1. Field of the Invention

The present invention relates to a grid for radiography using radiation such as X-rays, and a repairing method of the grid, and a radiation imaging system.

2. Description Related to the Prior Art

When radiation, for example, X-rays are incident upon an object, the intensity and phase of the X-rays are changed by interaction between the X-rays and the object. At this time, it is known that the phase change (angular change) of the X-rays is larger than the intensity change. Taking advantage of these properties of the X-rays, X-ray phase imaging is developed and actively researched to allow obtainment of a high-contrast image (hereinafter called phase contrast image) of a sample having low X-ray absorptivity based on the phase change (angular change) of the X-rays caused by the sample.

There is known an X-ray imaging system for carrying out the X-ray phase imaging using the Talbot effect, which is produced with two transmissive diffraction gratings or grids (refer to U.S. Pat. No. 7,180,979 corresponding to Japanese Patent No. 4445397 and Applied Physics Letters Vol. 81, No. 17, page 3287 written by C. David et al. on October 2002, for example). In this X-ray imaging system, a first grid is disposed behind a sample when viewed from the side of an X-ray source, and a second grid is disposed downstream from the first grid by the Talbot distance. Behind the second grid, an X-ray image detector is disposed to detect X-rays and produce an image. Each of the first and second grids has X-ray absorbing portions and X-ray transparent portions, which extend in one direction and are alternately arranged in a direction orthogonal to its extending direction. The Talbot distance refers to a distance at which the X-rays having passed through the first grid form a self image of the first grid by the Talbot effect. The self image formed by the Talbot effect is modulated by the interaction between the sample and the X-rays.

In the above X-ray imaging system, a plurality of fringe images, which are produced by superimposition (intensity modulation) of the second grid on the self image of the first grid, are detected by a fringe scanning method, in order to detect the phase change of the X-rays due to the sample from variation in the fringe images due to the sample. In the fringe scanning method, the X-ray image detector captures the image, whenever the second grid is translationally moved relative to the first grid in a direction approximately orthogonal to a grid direction at predetermined pitch. From the intensity change of each and every pixel value relative to the translational movement, the angular distribution of the X-rays refracted by the sample is obtained. Based on this angular distribution, the phase contrast image of the sample is obtained. The fringe scanning method is also applied to an imaging system using laser light (refer to Applied Optics Vol. 37, No. 26, page 6227 written by Hector Canabal et al. on September 1998, for example).

In the first and second grids, the arrangement pitch of the X-ray absorbing portions and the X-ray transparent portions is minute i.e. several micrometers. Thus, a minute manufacturing error, adhesion of dust, and the like easily cause partial deformation (grid defect) of the grid (refer to U.S. Pat. No. 7,924,973 corresponding to Japanese Patent Laid-Open Publication No. 2009-150875, for example). However, the U.S. Pat. No. 7,924,973 does not describe making repairs on the grid defect, when the defect occurs.

On the other hand, the repair of the grid defect is known in the field of a hologram color filter for holography, which is different from the grid for radiography though. Specifically, when the defect occurs, a small diffraction grating is glued on a defective portion to repair the defect (refer to Japanese Patent Laid-Open Publication No. 9-281442). According to this grid repairing method, a grid is partitioned into plural small sections in advance. When the defect occurs in some small section, the diffraction grating of the same size as the small section is glued on the defective small section.

When the defect occurs in the grid for radiography, abandoning the entire grid decreases productivity and increases costs. Thus, it is desirable to make repairs on the defect and use the grid as long as possible. However, the grid repairing method described in the Japanese Patent Laid-Open Publication No. 9-281442 is predicated on the grid partitioned into the plural small sections, and the repair is made on a small section basis. Therefore, even if this repairing method is applied to the grid for radiography, the repair is not appropriately compliant with the shape, size, and position of the defect.

### SUMMARY OF THE INVENTION

An object of the present invention is to provide a grid for radiography and a grid repairing method in which a defect of the grid is efficiently repaired.

To achieve the above and other objects, a grid for radiography according to the present invention includes a rectangular cutout being cut out along first and second directions, and a micro grid fitted into the cutout. The micro grid is smaller in size than the cutout, and is fitted into the cutout with leaving a gap. The gap is filled with a radiation absorbing material. The radiation absorbing material is preferably an Ag paste or a low melting metal of one of Sn—Pb, Sn—Pb—Bi, and Sn—Pn—Bi—Cd. In another case, the radiation absorbing material is preferably ink or adhesive in which X-ray absorptive nanoparticles of one or a plurality of Au, Ag, and Pt are dispersed. The grid may include a support substrate for supporting the radiation absorbing portions, the radiation transparent portions, and the micro grid.

A grid repairing method according to the present invention includes the steps of detecting the defective portion in the grid; determining the rectangular area to be cut out so as to enclose the defective portion, wherein two opposite sides of the rectangular area are parallel to the first direction, and the other two opposite sides of the rectangular area are parallel to the second direction; cutting out the rectangular area to form the cutout; fitting the micro grid into the cutout such that two adjoining sides of the micro grid are in contact with two adjoining sides of the cutout, wherein the micro grid is smaller in size than the cutout; and fixing the micro grid in the cutout. In the fixing step, the radiation absorbing material is charged into the gap left between an outline of the cutout and the micro grid.

A radiation imaging system according to the present invention includes a first grid for passing radiation emitted from a radiation source to produce a first periodic pattern image, and a second grid for partly blocking the first periodic pattern image to produce a second periodic pattern image. At least one of the first and second grids is the grid described above.

According to the present invention, the rectangular area is determined so as to enclose the defective portion, and the area is cut out. The micro grid, which is smaller than the outline of the cutout, is prepared. The micro grid is fitted into the cutout such that the two adjoining sides of the micro grid are in contact with the two adjoining sides of the cutout, and the micro grid is fixed in the cutout. Thus, the defective portion is efficiently repaired. The micro grid is usable as a marker for adjusting the position of the grid when assembling the radiation imaging system.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is a schematic view of an X-ray imaging system according to a first embodiment;

FIG. 2 is a top plan view of a second grid;

FIG. 3 is a cross sectional view of the second grid taken on the line I-I of FIG. 2;

FIG. 4 is an explanatory view of a manufacturing process of the second grid;

FIG. 5 is an explanatory view of a grid repairing method;

FIG. 6 is an explanatory view of the grid repairing method; and

FIG. 7 is an explanatory view showing a state of position adjustment using a ruler.

### DESCRIPTION OF THE PREFERRED EMBODIMENTS

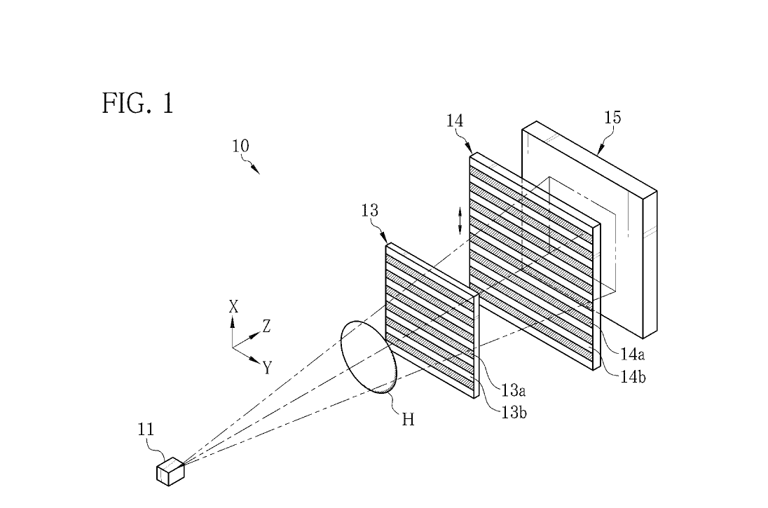

As shown in FIG. 1, an X-ray imaging system 10 is constituted of an X-ray source 11, a first grid 13, a second grid 14, and an X-ray image detector 15. The X-ray source 11 has, for example, a rotating anode type X-ray tube and a collimator for limiting an irradiation field of X-rays, and applies the X-rays to a sample H. The first and second grids 13 and 14, being X-ray absorption grids, are opposed to the X-ray source 11 in an X-ray propagation direction i.e. Z direction. The first grid 13 is disposed at a certain distance away from the X-ray source 11 so as to place the sample H therebetweeen. The X-ray image detector 15 is a flat panel detector (FPD) composed of semiconductor circuitry, for example, and is disposed behind the second grid 14.

The first grid 13 is provided with a plurality of X-ray absorbing portions 13a and X-ray transparent portions 13b, which extend in a Y direction being one direction in a plane orthogonal to the Z direction. The X-ray absorbing portions 13a and the X-ray transparent portions 13b are alternately arranged in an X direction orthogonal to both the Z and Y directions. As with the first grid 13, the second grid 14 is provided with a plurality of X-ray absorbing portions 14a and X-ray transparent portions 14b, which extend in the Y direction and are alternately arranged in the X direction.

The structure of the grid will be hereinafter described with taking the second grid 14 as an example. Note that, the first grid 13 has structure similar to that of the second grid 14, except for the width and pitch of the X-ray absorbing portion 13a in the X direction, the thickness of the X-ray absorbing portion 13a in the Z direction, and the like. Thus, the detailed description of the first grid 13 is omitted.

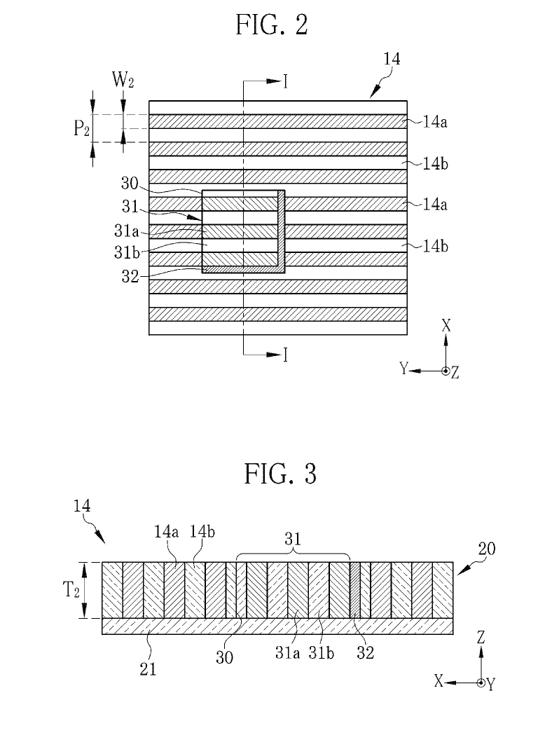

As shown in FIGS. 2 and 3, the second grid 14 is provided with a grid layer 20 having the X-ray absorbing portions 14a and the X-ray transparent portions 14b, and a support substrate 21 for supporting the grid layer 20. The X-ray absorbing portion 14a is made of a metal with X-ray absorptivity, such as gold (Au) or platinum (Pt). The X-ray transparent portion 14b is made of a material with X-ray transparency, such as silicon or resin.

In the second grid 14, the grid layer 20 is cut out along the X and Y directions to form a rectangular cutout 30. This cutout 30 has been made aiming to remove a defective portion that occurred in the grid layer 20. Two opposite sides of the cutout extending in the Y direction are situated in the X-ray transparent portions 14b. Into the cutout 30, a rectangular micro grid 31 of size a little smaller than the cutout 30 is fitted.

The micro grid 31 is in contact with two adjoining sides of the cutout 30 so as to leave a gap between the micro grid 31 and noncontact sides of the cutout 30. The gap is filled with an X-ray absorbing material 32. The X-ray absorbing material 32 is a low melting metal having the X-ray absorptivity, such as Sn—Pb. The X-ray absorbing material 32 has the function of gluing the micro grid 31 onto the grid layer 20. If the gap is left between the micro grid 31 and the noncontact sides of the cutout 30, the gap can disperse the X-rays and degrade image quality. The X-ray absorbing material 32 also has the function of preventing the occurrence of dispersed X-rays in the gap.

Similarly to the grid layer 20, the micro grid 31 has X-ray absorbing portions 31a and X-ray transparent portions 31b, which extend in one direction and are alternately arranged in a direction orthogonal to the extending direction. The X-ray absorbing portion 31a is made of a metal with X-ray absorptivity such as gold or platinum. The X-ray transparent portion 31b is made of a material with X-ray transparency such as silicon or resin. The micro grid 31 is fitted into the cutout 30 in such a manner that the X-ray absorbing portions 31a are aligned with the X-ray absorbing portions 14a of the grid 20, and the X-ray transparent portions 31b are aligned with the X-ray transparent portions 14b at their width and position in the X direction.

The width W₂ and arrangement pitch P₂ of the X-ray absorbing portions 14a in the X direction depend on the distance between the X-ray source 11 and the first grid 13, the distance between the first and second grids 13 and 14, the arrangement pitch of the X-ray absorbing portions 13a of the first grid 13, and the like. By way of example, the width W₂ is approximately 2 to 20 μm, and the arrangement pitch P₂ is twice as large as the width W₂, i.e. in the order of 4 to 40 μm. The thickness T₂ of the X-ray absorbing portions 14a is in the order of 100 μm, for example, in consideration of the vignetting of a cone beam of X-rays emitted from the X-ray source 11. In this embodiment, the second grid 14 has a width W₂ of 2.5 μm, an arrangement pitch P₂ of 5 μm, and a thickness T₂ of 100 μm, for example.

Next, the operation of the X-ray imaging system 10 will be described. When the X-rays emitted from the X-ray source 11 pass through the sample H, the phase of the X-rays is changed. Subsequently, when the X-rays transmit through the first grid 13, a first periodic pattern image including the transmission phase information of the sample H, which is determined by the refractive index of the sample H and the length of a transmission optical path, is formed.

The second grid 14 partly blocks the first periodic pattern image, in other words, applies intensity modulation to the first periodic pattern image to form a second periodic pattern image. In this embodiment, adopting a fringe scanning method, the second grid 14 is translationally moved relative to the first grid 13 by a scan pitch that is an equal division (for example, one-fifth) of the grid pitch in the X direction along a grid surface with respect to an X-ray focus. Whenever the second grid 14 is translationally moved, the X-ray source 11 applies the X-rays to the sample H, and the X-ray image detector 15 captures the second periodic pattern image. Then, by calculating a phase shift amount of an intensity modulation signal (waveform signal representing the intensity change of a pixel value relative to the translational movement) from each pixel of the X-ray image detector 15, a differential phase image is obtained. The differential phase image corresponds to the angular distribution of the X-rays refracted by the sample H. The differential phase image is integrated along a fringe scanning direction to obtain a phase contrast image of the sample H.

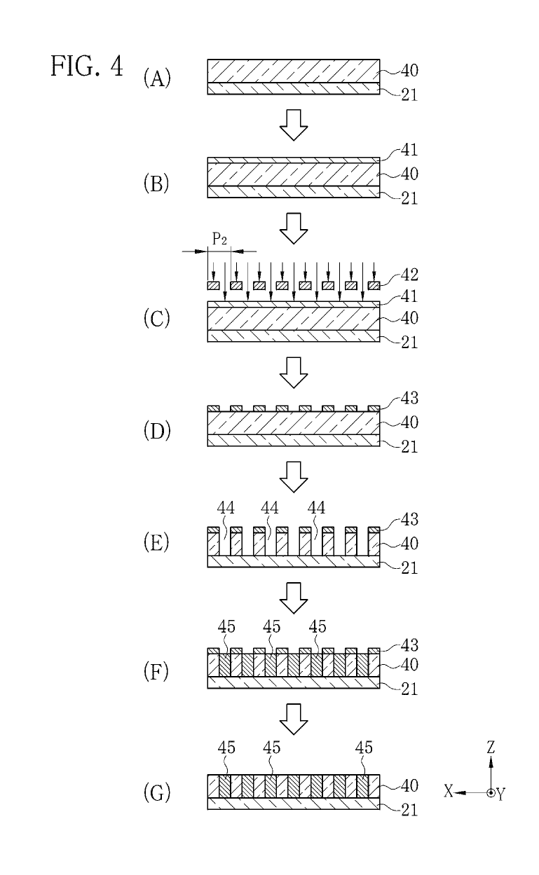

Next, a manufacturing method of the second grid 14 will be described with referring to FIGS. 4 to 6. Note that, since the first grid 13 is manufactured in a way similar to that of the second grid 14, a manufacturing method of the first grid 13 will not be described.

In FIG. 4(A), a silicon substrate 40 is joined to the support substrate 21. The support substrate 21 is made of an electrically conductive material such as aluminum or chromium. It is preferable that the difference in a coefficient of thermal expansion between the support substrate 21 and the silicon substrate 40 is small, and the support substrate 21 may be made of Kovar, Invar, or the like. To join the support substrate 21 and the silicon substrate 40, diffused junction being performed with application of heat and pressure, cold junction by which a surface is activated in a high vacuum, or the like is available.

In FIG. 4(B), a resist layer 41 is formed on a top surface of the silicon substrate 40. A forming procedure of the resist layer 41 includes the step of applying a liquid resist on the silicon substrate 40 by an application method such as spin coating, and the step of prebaking for evaporating an organic solvent from the applied liquid resist.

In FIG. 4(C), light such as ultraviolet rays is applied to the resist layer 41 through a stripe-pattern exposure mask having the pitch P₂. Then, in FIG. 4 (D), the resist layer 41 is removed at exposed portions by a development process. Accordingly, a stripe-pattern etching mask 43, which has a pattern of plural lines extending in the Y direction and being arranged in the X direction, is formed on the silicon substrate 40. Note that, the resist layer 41 is a positive resist in this embodiment, but a negative resist may be used instead.

In FIG. 4(E), a plurality of grooves 44, which extend in the Y direction and are arranged in the X direction, are formed in the silicon substrate 40 by dry etching using the etching mask 43. In this step, a so-called Bosch process is used as a method for deep dry etching to form the grooves 44 with a high aspect ratio. Instead of the Bosch process, a cryo process may be used as a method for dry etching.

In FIG. 4(F), electrolytic plating is performed using the support substrate 21 as a seed layer, so the grooves 44 are filled with the X-ray absorbing material 45 such as gold (Au). In this electrolytic plating step, a junction substrate composed of the support substrate 21 and the silicon substrate 40 is immersed in a plating solution as a negative electrode, and the other electrode (positive electrode) is disposed in a position opposite to the junction substrate. After that, when electric current flows between the support substrate 21 and the positive electrode, metal ions contained in the plating solution are deposited on the patterned substrate, so the grooves 44 are filled with the X-ray absorbing material 45.

In FIG. 4(G), the etching mask 43 are removed from the silicon substrate 40 by asking or the like. The X-ray absorbing material 45 composes the X-ray absorbing portions 14a, and the silicon substrate 40 composes the X-ray transparent portions 14b. The second grid 14 is completed by the above process, but a grid defect sometimes occurs in the second grid 14 due to failure in the etching or the electrolytic plating, adhesion of dust, and the like.

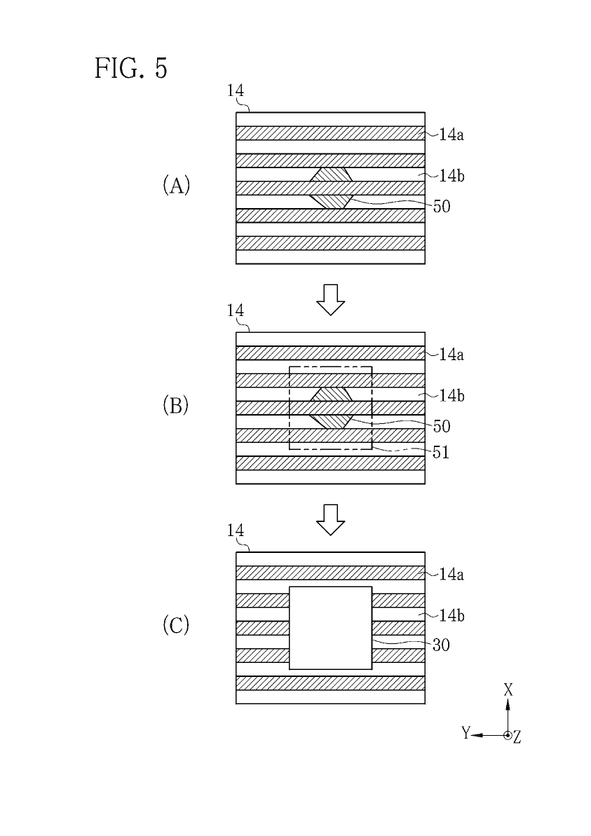

Next, a method for repairing the defect having occurred in the second grid 14 will be described. First, after the above manufacturing process, a visual inspection device (not shown) takes an image of the second grid 14. By processing the image, a defective portion 50 is found as shown in FIG. 5(A). The defective portion 50 having the X-ray absorptivity emerges, when a cavity occurs by poor etching of the silicon substrate 40, and the cavity is filled with the X-ray absorbing material 45 by the electrolytic plating step, for example.

In FIG. 5(B), a rectangular area 51 composed of the sides parallel to the X and Y directions is determined so as to enclose the defective portion 50. The two opposite sides of the area 51 along the Y direction are situated in the X-ray transparent portions 14b. Note that, if a plurality of defective portions 50 are found, the area 51 is determined on a defective portion 50 basis. Then, as shown in FIG. 5(C), the grid layer 20 is cut out by a laser or the like along an outline of the area 51, so the cutout 30 described above is formed.

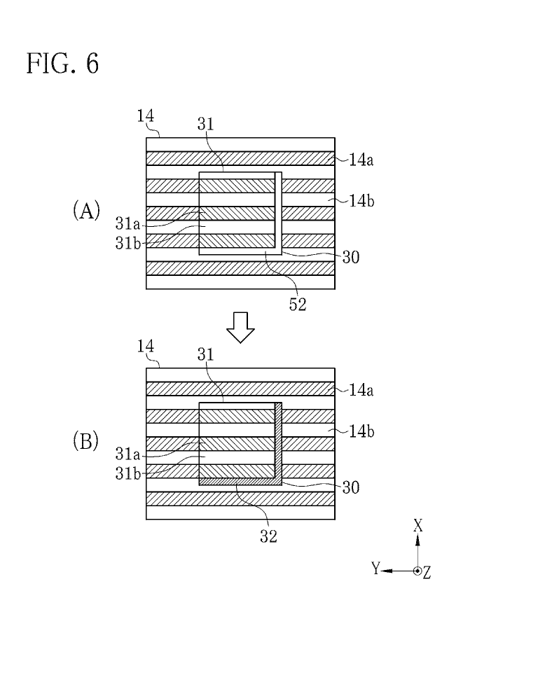

In FIG. 6(A), the micro grid 31 is prepared and disposed in the cutout 30 such that the two adjoining sides of the micro grid 31 make contact with the two adjoining sides of the cutout 30, as described above. At this time, a gap 52 is left between the micro grid 31 and the cutout 30. Thus, the X-ray absorbing material 32 such as Sn—Pb of a molten state is charged into the gap 52. When the X-ray absorbing material 32 is solidified, the micro grid 31 adheres to the grid layer 20. A repairing process of the defective portion 50 is now completed.

The area 51 to be cut out may always have the same shape and size, or may have variable shape and size in accordance with the shape and size of the defective portion 50. However, if the area 51 has the freely variable shape and size, the micro grid 31 has to be newly created in accordance with the shape and size of the area 51 formed in the second grid 14, whenever the shape and size of the area 51 is changed, and resulting in a heavy burden. For this reason, it is preferable to prepare plural types of template areas of reasonable shapes and sizes. In this case, plural types of micro grids 31 corresponding to the plural types of template areas 51 are prepared in advance. When the area 51 to be cut out is determined in the second grid 14, the micro grid 31 of the type corresponding to that of the area 51 is selected.

According to another grid repairing method in which the defective portion 50 is cut out along its outline and a micro grid is created in accordance with the outline to bond the micro grid in a cutout of the defective portion 50, forming the cutout and the micro grid of arbitrary shape needs much time and effort, and brings about inefficiency. On the other hand, according to this embodiment, the rectangular area 51 to be cut out is determined so as to enclose the defective portion 50, and the cutout 30 is formed. The micro grid 31 is selected from the plural types in accordance with the shape and size of the cutout 30. Therefore, it is possible to repair the defective portion 50 in a rapid and efficient manner.

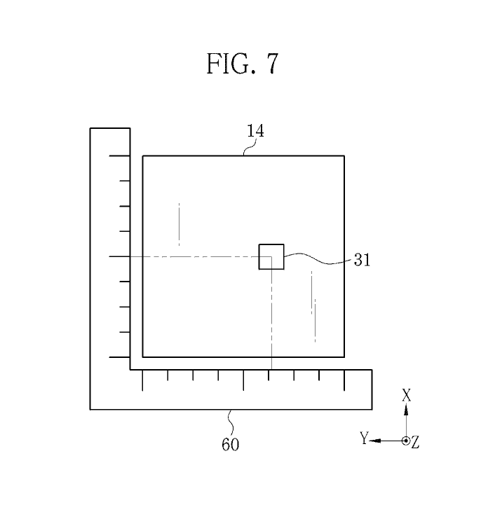

In assembling the X-ray imaging system 10, the micro grid 31 of the second grid 14 is usable as a marker for adjusting the position of the second grid 14. To be more specific, the position of the micro grid 31 in the second grid 14 is stored in advance. In adjusting the position of the second grid 14, the position of the micro grid 31 is measured using a ruler 60 disposed around the second grid 14, as shown in FIG. 7, to detect a positional deviation of the second grid 14. To measure the position of the micro grid 31, for example, a visible light camera takes an image of the second grid 14 and the ruler 60. From this image, the position of the X-ray absorbing material 32 with respect to the ruler 60 is detected to specify the position of the micro grid 31. The same goes for the first grid 13, so description thereof is omitted.

In the above embodiment, the two opposite sides of the rectangular area 51 along the Y direction are situated in the X-ray transparent portions 14b, but may be situated in the X-ray absorbing portions 14a instead. Furthermore, one of the two opposite sides may be situated in the X-ray transparent portion 14b, and the other may be situated in the X-ray absorbing portion 14a.

In the above embodiment, Sn—Pb is used as the X-ray absorbing material 32 by way of example, but an Ag paste or a low melting metal such as Sn—Pb—Bi or Sn—Pn—Bi—Cd may be used instead. Also, the X-ray absorbing material 32 may be ink, adhesive, or the like in which nanoparticles of one or some of Au, Ag, and Pt are dispersed.

In the above embodiment, the present invention is explained with taking the first and second grids 13 and 14 as an example. However, the present invention may be applied to a source grid (multi-slit) disposed in an outlet side of the X-ray source 11, as disclosed in U.S. Pat. No. 7,889,838 corresponding to International Publication No. WO 2006/131235.

In the above embodiments, the first and second grids 13 and 14 linearly project the X-rays that have passed through their X-ray transparent portions 13b and 14b, but the present invention is not limited to this structure. The X-ray transparent portions may diffract the X-rays, and produce the so-called Talbot effect (refer to U.S. Pat. No. 7,180,979 corresponding to Japanese Patent No. 4445397). In this case, the distance between the first and second grids 13 and 14 has to be set at the Talbot distance. Also, the first grid 13 may be a phase grid, instead of an absorption grid. The first grid 13 forms a self image, which is produced by the Talbot effect, at the position of the second grid 14.

In the above embodiment, the phase contrast image is produced by capturing the images plural times with changing the relative position between the first and second grids 13 and 14. However, the phase contrast image may be produced by capturing a single image using the first and second grids 13 and 14 in fixed positions. For example, according to an X-ray imaging system disclosed in U.S. Pat. No. 7,009,797 corresponding to International Publication No. WO 2010/050483, an X-ray image detector detects moiré fringes produced by first and second grids. The intensity distribution of the detected moiré fringes is applied to the Fourier transform to obtain a spatial frequency spectrum. From the spatial frequency spectrum, a spectrum corresponding to a carrier frequency is separated, and the separated spectrum is applied to the inverse Fourier transform to obtain the differential phase image. The grid of the present invention is applicable to the X-ray imaging system of this type.

In the above embodiment, the sample H is disposed between the X-ray source 11 and the first grid 13, but may be disposed between the first and second grids 13 and 14 instead. In this case, the phase contrast image is produced in a like manner.

The embodiments described above are applicable not only to a radiation imaging system for medical diagnosis, but also to other types of radiation imaging systems for industrial use, nondestructive inspection, and the like. The present invention is also applicable to a grid for removing scattered light in radiography. Furthermore, in the present invention, gamma-rays may be used as radiation instead of the X-rays.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. A grid for radiography having radiation absorbing portions and radiation transparent portions, said radiation absorbing portions and said radiation transparent portions extending in a first direction, and being alternately arranged in a second direction orthogonal to said first direction, said grid comprising:
a rectangular cutout being cut out along said first and second directions; and
a micro grid fitted into said cutout.

2. The grid according to claim 1,
wherein said micro grid is smaller in size than said cutout, and is fitted into said cutout with leaving a gap; and
wherein said gap is filled with a radiation absorbing material.

3. The grid according to claim 2, wherein said radiation absorbing material is an Ag paste or a low melting metal of one of Sn—Pb, Sn—Pb—Bi, and Sn—Pn—Bi—Cd.

4. The grid according to claim 2, wherein said radiation absorbing material is ink or adhesive in which X-ray absorptive nanoparticles of one or a plurality of Au, Ag, and Pt are dispersed.

5. The grid according to claim 1, further comprising:
a support substrate for supporting said radiation absorbing portions, said radiation transparent portions, and said micro grid.

6. A method for repairing a grid having radiation absorbing portions and radiation transparent portions, said radiation absorbing portions and said radiation transparent portions extending in a first direction and being alternately arranged in a second direction orthogonal to said first direction, said method comprising the steps of:
detecting a defective portion in said grid;
determining a rectangular area to be cut out so as to enclose said defective portion, two opposite sides of said rectangular area being parallel to said first direction, the other two opposite sides of said rectangular area being parallel to said second direction;
cutting out said rectangular area to form a cutout;
fitting a micro grid into said cutout such that two adjoining sides of said micro grid are in contact with two adjoining sides of said cutout, said micro grid being smaller in size than said cutout; and
fixing said micro grid in said cutout.

7. The method according to claim 6, wherein in the fixing step, a radiation absorbing material is charged into a gap left between an outline of said cutout and said micro grid.

8. The method according to claim 7, wherein said radiation absorbing material is an Ag paste or a low melting metal of one of Sn—Pb, Sn—Pb—Bi, and Sn—Pn—Bi—Cd.

9. The method according to claim 7, wherein said radiation absorbing material is ink or adhesive in which X-ray absorptive nanoparticles of one or a plurality of Au, Ag, and Pt are dispersed.

10. A radiation imaging system comprising:
a first grid for passing radiation emitted from a radiation source to produce a first periodic pattern image; and
a second grid for partly blocking said first periodic pattern image to produce a second periodic pattern image;
wherein, at least one of said first and second grids has radiation absorbing portions and radiation transparent portions extending in a first direction and being alternately arranged in a second direction orthogonal to said first direction, and includes:
a rectangular cutout being cut out along said first and second directions; and
a micro grid fitted into said cutout.
